(19) United States
(12) Patent Application Publication
(10) Pub. No.: US 2009/0316038 A1
(43) Pub. Date: Dec. 24, 2009

(54) MODULAR CAMERA SYSTEM

(76) Inventors: Andreas Schmack, Leonberg (DE); Rainer Moritz, Filderstadt (DE); Heiner Hild, Ludwigsburg (DE)

Correspondence Address: KENYON & KENYON LLP, ONE BROADWAY, NEW YORK, NY, 10004, US

(21) Appl. No.: 12/305,176

(22) PCT Filed: Jul. 18, 2007
(86) PCT No.: PCT/EP07/57446

§ 371 Date: Apr. 29, 2009

(30) Foreign Application Priority Data
Sep. 13, 2006 (DE) 102006043010.7

(51) Int. Cl. H04N 5/225

(52) U.S. Cl. 348/373; 348/E05.024

(57) ABSTRACT

A modular camera system, including a camera which is disposed in a first housing that has a first contact element, and a signal processing and control unit which is disposed in a second housing that has a second contact element, the first housing being couplable with the second housing in a manner disposed so as to abut in planar fashion, and when disposed so as to abut in planar fashion, the first contact element being connected to the second contact element.

### FIELD OF THE INVENTION

The present invention relates to a modular camera system, in particular to a modular camera system for use in motor vehicles.

### BACKGROUND OF THE INVENTION

Driving a motor vehicle becomes considerably more difficult in poor weather conditions or at night. This also results in a relatively higher accident rate as compared with good weather conditions during the day. Infrared camera systems can sense obstacles and possible sources of risk on the road even at night or in poor weather conditions, and evaluation devices can detect these sources of risk and inform the vehicle driver by way of suitable indicating devices.

In one common assemblage, the camera is mounted close to the rear-view mirror, i.e, centeredly behind the vehicle's windshield. The size of the space available there depends on the configuration of the interior of the vehicle in question. The camera systems and associated evaluation devices must therefore adapted, in terms of their space requirement, to the various vehicle models. In many vehicle models the camera system must be divided into two components, and control devices must be disposed separately from the camera.

This leads to the need to make available a large variety of different camera systems so that they can be integrated into the various vehicle models.

### SUMMARY

An example modular camera system according to the present invention, creates a camera system that is universally usable for all vehicle models.

The example modular camera system according to the present invention includes:
a camera which is disposed in a first housing that has a first contact element, and
a signal processing and control unit which is disposed in a second housing that has a second contact element,
the first housing being disposable so as to abut in planar fashion against the second housing, and when disposed so as to abut in planar fashion, the first contact element being connected to the second contact element.

One aspect of the example embodiment of the present invention is that the camera can readily be disposed separately from the signal processing and control unit, or in a manner fitted together with it, depending on the space available. One-time development of the two components of the modular camera system is therefore sufficient, and universal use is guaranteed.

Disposition so as to abut in planar fashion may encompass a form-locking disposition.

The first contact element can be a male plug connector and the second contact element can be a female plug connector, or conversely the first contact element can be a female plug connector and the second contact element can be a male plug connector. It is also possible for the first contact element and the second contact element to be female connectors, and for a coupling piece having two male plug connectors to be interposed for connecting the first and the second housing.

In one example embodiment, the first housing is placeable separately from the second housing, and the first contact element is connected to the second contact element via a connecting cable when the first housing is placed separately from the second housing.

The first contact element and the second contact element can be respectively disposed in a countersink in the first and the second housing. The countersink is preferably deep enough to receive a plug element of the connecting cable. As a result, the connecting cable is securely fastened and the space requirement is reduced, since the plug element does not protrude.

According to an example embodiment, the camera has a deactivatable conductor driver and/or the signal processing and control unit has a deactivatable conductor driver, and the deactivatable conductor drivers are deactivated when the first housing is disposed so as to abut in planar fashion against the second housing. Deactivation can be performable by the contact element itself, or manually. The advantage of deactivating the conductor driver is the lower power consumption and the lower radiation of high-frequency signals of the two camera system components.

### BRIEF DESCRIPTION OF THE DRAWINGS

The present invention is described in detail below by way of example with reference to preferred exemplifying embodiments and to the figures.

FIG. 1 shows a component of a first embodiment.

FIG. 2 shows the first embodiment in a separate disposition.

FIG. 3 shows the first embodiment in a continuous disposition.

FIG. 4 shows a second embodiment in a separate disposition.

FIG. 5 shows the second embodiment in a continuous disposition.

FIG. 6 shows a third embodiment.

### DETAILED DESCRIPTION OF EXAMPLE EMBODIMENTS

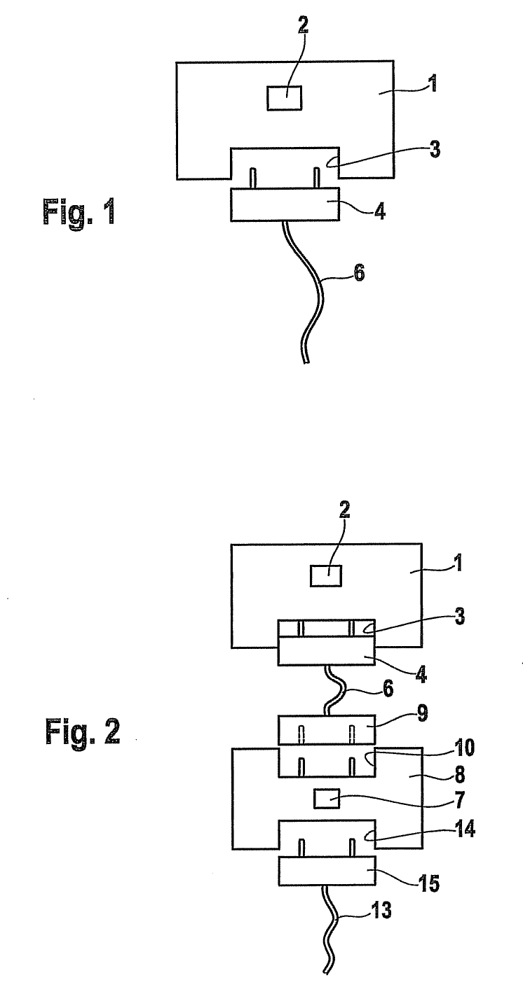

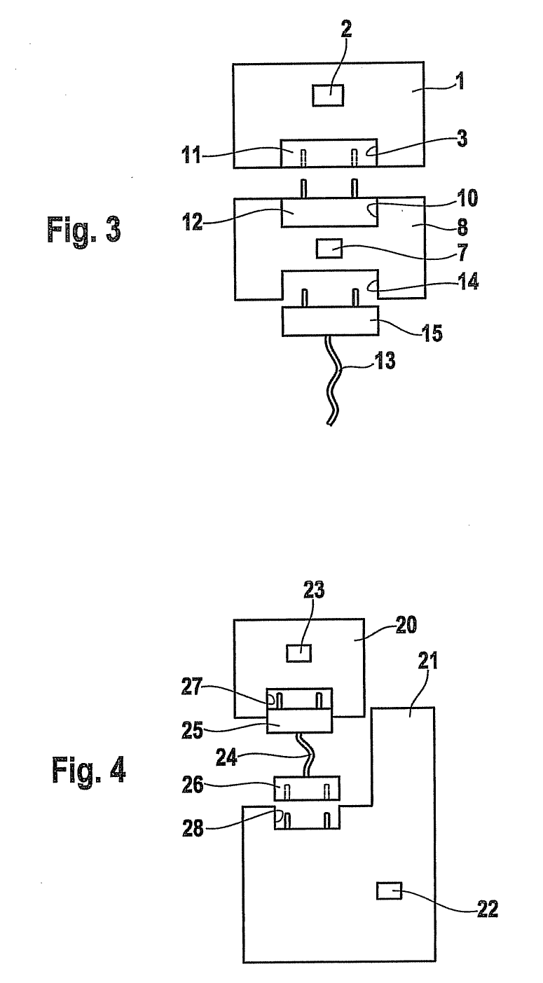

FIG. 1 depicts, in a first example embodiment, a housing 1 into which a camera 2 is integrated. Housing 1 preferably has external dimensions that can readily be installed into most vehicle models. The mirror mount is preferred as a location for installation. For other systems, camera 2 with housing 1 is integrated into or near the headlights. Housing 1 has a socket 3 for a plug 4. Socket 3 can be equipped with a male or a female contact. Spring contacts, clamp contacts, or two-dimensional contacts can also be provided. By way of these contacts, camera 2 is connected to the necessary power-supply conductors, data signal conductors, and control conductors. Camera 2 can thus be connected, via an access conductor 6 having a plug 4 corresponding to socket 3, to a signal processing and control unit.

The first example embodiment is shown in FIG. 2. Camera 2 is integrated into housing 1. A signal processing and control unit 7 is integrated into a second housing 8. The two housings 1, 8 are units separated from one another. A connection between the two housings 1, 8, and the electronic components 2, 7 present therein, is made by way of conductor 6 and its associated plugs 4, 9. Plug 4 is adapted to socket 3 of first housing 1. Plug 9 is adapted to socket 10 of second housing 8. First housing 1 and second housing 8 can be disposed separately from one another in accordance with the length of conductor 6.

If it is possible to dispose first housing 1 and second housing 8 together at a desired location, no conductor 6 is used. Instead, a connection between first housing 1 and second housing 8 is achieved via coupling pieces 11 and 12 that are inserted into sockets 3 and 10, respectively. First housing 1 can thus be disposed so as to abut in planar fashion against second housing 8, thereby minimizing the overall space requirement.

A connection to further components can be made available via a second conductor 13 that is connected to first housing 8 via a corresponding socket 14 and a plug 15.

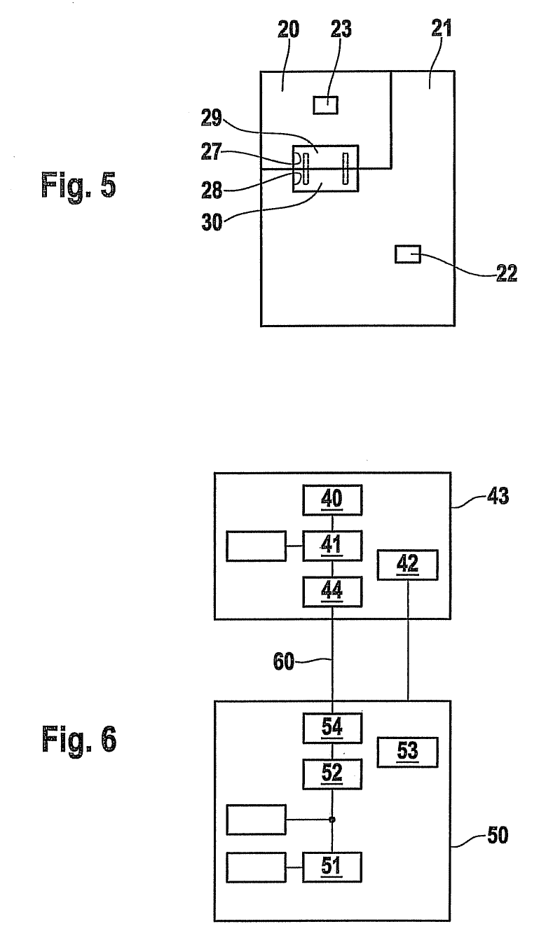

A second example embodiment is depicted in FIG. 4. A housing 21 having signal processing and control unit 22 has a cutout into which housing 20 of camera 23 is conformingly insertable. With a first disposition, the two housings 20, 21 are connected via a conductor 24 having plug connections 25, 26 or other contact elements. Housings 20, 21 have associated sockets 27, 28. With a second disposition (FIG. 5), housing 20 of camera 23 is inserted conformingly into housing 21 of signal processing and control unit 22. Corresponding coupling pieces 29 and 30 ensure a connection between the mutually oppositely located sockets 27, 28 of the two housings 20, 21.

In an example embodiment that is not depicted, contact elements 27, 28 of the two housings 20, 21 can be flush with the external surfaces of the two housings 20, 21. In this case no coupling piece 29, 30 between the two housings 20, 21 is necessary in order to ensure a connection between housings 20, 21 that are disposed conformingly with respect to one another.

FIG. 6 schematically depicts a third example embodiment and its electronic configuration. Camera 40 is disposed, with an interface logic module 41 and a power supply 42, in a first housing 43. A microprocessor 51, with an interface module 52 and a power supply 53, is disposed in a second housing 50. Communication between camera 40 and microprocessor 51 is ensured by a connection 60. Connection 60 can be implemented, in accordance with the exemplifying embodiments described previously, by way of a conductor in a context of separate disposition of the two components 40, 51, or by way of coupling pieces or direct contact between the two housings 43, 50.

Interface drivers 44 and 54 are additionally disposed in the two housings 43, 50. These are necessary in order to increase the signal strength when the signals must be transmitted over a longer travel length, i.e., via a conductor. Optimally, these interface drivers 44, 54 can be switched off when first housing 43 and second housing 50 are in contact with one another, i.e., the travel length between the two housings 43, 50 is minimal. The two interface drivers 44, 54 can be switched off manually by closing or opening suitable bridges.

In another example embodiment, a contact pair is disposed on first housing 43, and a contact bridge corresponding to the contact pair is disposed on second housing 50. If the two housings 43, 50 are disposed conformingly with respect to one another, the contact bridge short-circuits the two contacts. This is sensed by a sensor device, and the interface driver is thereupon deactivated. In similar fashion, a contact pair is disposed on second housing 50, and a contact bridge on first housing 43.

In a further example variant, the electronic configuration is not populated with the interface drivers when it is certain that the modular camera system will be disposed as one piece.

Deactivation of the interface drivers decreases the power consumption of the two camera system components. Furthermore, the electromagnetic radiation is also reduced, especially as a result of the data signals transmitted at high frequency.

The housing of the camera and the housing of the control device fit into one another. In the fitted-together state, a plug adapter can additionally be disposed between the two housings in order to bridge the mechanical gap. This can be regarded as a connecting cable having a length of zero meters.

Holding, guiding, and latching devices can be disposed on the housings to ensure mutual retention of the two housings.

The plugs used can be fine-pitch plugs. Ribbon cables can be used as cables or conductors.

1-8. (canceled)

9. A modular camera system, comprising:
a camera which is disposed in a first housing that has a first contact element; and
a signal processing and control unit which is disposed in a second housing that has a second contact element;
wherein the first housing is couplable with the second housing in a manner disposed so as to abut in planar fashion, and when disposed so as to abut in planar fashion, the first contact element being connected to the second contact element.

10. The modular camera system as recited in claim 9, wherein one of: i) the first contact element is a male plug connector and the second contact element a female plug connector, or ii) the first contact element is a female plug connector and the second contact element is a male plug connector.

11. The modular camera system as recited in claim 9, wherein the first contact element and the second contact element are female connectors, and a coupling piece having two male plug connectors is interposed for connecting the first and the second contact element.

12. The modular camera system as recited in claim 9, wherein the first housing is placeable separately from the second housing, and the first contact element is connected to the second contact element via a connecting cable when the first housing is placed separately from the second housing.

13. The modular camera system as recited in claim 12, wherein the first contact element and the second contact element are respectively disposed in a countersink in the first and the second housing.

14. The modular camera system as recited in claim 14, wherein the countersink is deep enough to receive a plug element of the connecting cable.

15. The modular camera system as recited in claim 9, wherein at least one of the camera has a deactivatable conductor driver, and the signal processing and control unit has a deactivatable conductor driver and the deactivatable conductor drivers are deactivated when the first housing is connected so as to abut in planar fashion against the second housing.

16. The modular camera system as recited in claim 9, wherein abutting in planar fashion encompasses abutting in a form-locking fashion.
